(19) United States
(12) Patent Application Publication
(10) Pub. No.: US 2011/0222162 A1
(43) Pub. Date: Sep. 15, 2011

(54) Optical Lens

(76) Inventors: Peter Helbig, Sontheim/Brenz (DE); Philipp Helbig, Heidenheim (DE)

(21) Appl. No.: 13/129,566

(22) PCT Filed: Nov. 4, 2009
(86) PCT No.: PCT/EP09/64635

§ 371 Date: May 16, 2011

(30) Foreign Application Priority Data
Nov. 14, 2008 (DE) 10 2008 057 355.8

(51) Int. Cl. G02B 3/00; G02B 1/00

(52) U.S. Cl. 359/642

(57) ABSTRACT

An optical lens, (1) is shaped like a hood and comprising a light transmissive front face and an adjacent sidewall (12), wherein the sidewall (12) and the front face (11) form different components of the optical lens (1), which are joined to one another by injection molding

The invention relates to an optical lens in accordance with the preamble of claim 1.

### I. PRIOR ART

An optical lens of this type is disclosed, for example, in DE 298 13 531 U1. This publication describes an optical lens for a vehicle headlight, the front side of which is formed by a central spherical or aspherical lens part and at least one spherical or aspherical lens ring which adjoins the central lens part via a circumferential face. On its border this optical lens has a ring-shaped circumferential flange, which serves as a retainer for the optical lens.

### II. SUMMARY OF THE INVENTION

The object of the invention is to provide an optical lens which permits improved functioning in conjunction with a light source and any other optical elements of a lighting unit.

This object is achieved according to the invention by an optical lens having the features of claim 1. Particularly advantageous embodiments of the invention are described in the dependent claims.

The optical lens according to the invention is characterized by its hood-like shape, which is formed by a light-transmissive front face and an adjacent sidewall, and by the fact that the front face and the sidewall of the optical lens are embodied as different components which are joined to each other by an injection molding technique.

By virtue of the hood-like shape of the optical lens the light source and any other optical elements of a lighting unit, such as a reflector for example, can be arranged under the hood-like optical lens, protected from external influences. Hence no covering panel is required for protecting the light source. The hood-like shape also makes it possible to dispense with retaining arrangements for the optical lens, since the sidewall of the hood-like optical lens itself can be used for securing it. Furthermore, by means of the hood-like shape of the optical lens it is possible to achieve a gas-tight arrangement of the light source and any other optical elements under the hood-like optical lens by sealing off the interface between the optical lens and a housing of a lighting unit which includes the optical lens as a component. In addition, since the front face and the sidewall are formed as separate components of the lens, joined to each other by means of injection molding, it is possible on the one hand to form the front face as light transmissive and the sidewall as non-transmissive to light, and on the other hand in spite of this to form the optical lens as a single piece.

Advantageously, the sidewall of the inventive optical lens is embodied to be non-transmissive to light, in order to use the sidewall as a shading device, so that light can only emerge through the front face which is equipped with the light refracting areas of the optical lens.

For the above-mentioned purpose, the front face and the sidewall are preferably made of different materials. For example, for the front face use can be made of a material which is highly transmissive to light and for the sidewall a non light-transmissive material.

The front face of the optical lens will therefore preferably consist of a material from the group of polycarbonate, polymethylacrylate and glass.

The sidewall will preferably consist of a material from the group of polycarbonate, in particular polycarbonate provided with coloring pigments, polyamide and polybutylenterephthalate.

Advantageously the sidewall, at least, will be embodied as an injection molded part, to permit simple and low cost manufacture and the use of an injection molding technique for the joint between the sidewall and the front face of the optical lens.

### III. DESCRIPTION OF THE PREFERRED EXEMPLARY EMBODIMENT

The invention is explained in more detail below with reference to a preferred exemplary embodiment and the drawing, in which:

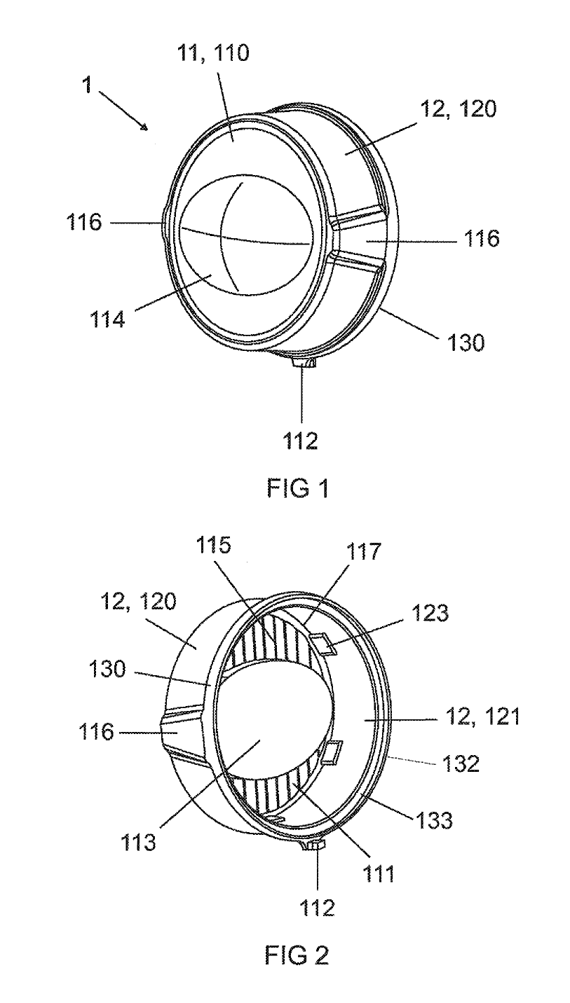

FIG. 1 shows a side view onto the outside of the optical lens embodied in a hood shape, according to the preferred exemplary embodiment of the invention

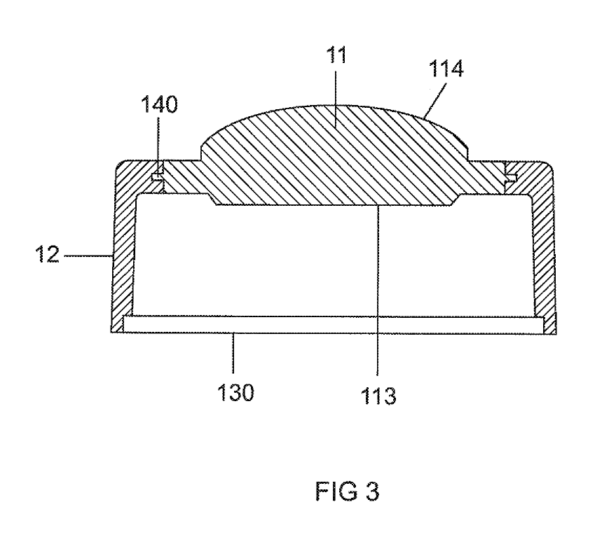

FIG. 2 shows a side view onto the inside of the optical lens depicted in FIG. 1

FIG. 3 shows a schematic representation of a cross-section through the optical lens depicted in FIGS. 1 and 2

FIGS. 1 and 2 shows different views of the optical lens according to the preferred exemplary embodiment of the invention. The optical lens 1 is shaped like a hood and embodied as a single piece. The optical lens 1 has a light transmissive front face 11 and a non light-transmissive ring-shaped sidewall 12. The front face 11 and the sidewall 12 adjacent to it form the hood shape of the optical lens 1. The front face 11 consists of polycarbonate and the sidewall consists of polybutylenterephthalate. FIG. 1 shows the outside or front side of the inventive optical lens 1 and hence also the outside 110 of its front face 11 and the outside 120 of its sidewall 12. FIG. 2 shows the inside of the hood-like optical lens 1. On its inside 111, the front face 11 has a first light-refracting area 113 which is arranged centrally on the front face 11, and which is delimited by an elliptical edge and is embodied as planar. Outside the first light-refracting area 113, the inside 111 of the front face 11 is provided with ribs 115 running parallel to one another which give light-scattering properties to the front face 11 in this area. On its outside 110, the front face 11 has a second light-refracting area 114 which is arranged centrally on the front face 11, is delimited by an elliptical edge and has a convex curvature. The first 113 and second light-refracting area 114 correspond to each other and form a non-rotationally-symmetrical, aspheric lens whose optical axis runs vertically with respect to the planar first light-refracting area 113 and coincides with the ring axis of the ring-shaped sidewall 12. Outside the second light-refracting area 114, the outside 110 of the front face 11 is embodied as planar. Owing to the ribs 115 arranged on its inside 111, the front face 11 possesses light-scattering properties outside the second light-refracting area 114. The front face 11 has an increased wall thickness in the region of the aspheric lens formed by the two light-refracting areas 113, 114. On its inside 111, the front face 11 also has a circular-ring-shaped, flat mating surface 117 which forms the outer edge of the front face 11 and can serve as a mating surface for a reflector of a lighting unit which includes the optical lens as a component. The sidewall 12 is embodied as slightly conical. In other words, the inner diameter and outer diameter of the sidewall 12 increase slightly with increasing distance from the front face 11. On the inside 121 of the sidewall 12, in the immediate proximity of the front face 11, there are five projections 123, projecting into the interior of the hood-like optical lens 1, arranged equidistantly around its circumference. Arranged on the inside there is in addition a reference lug 125 projecting into the interior of the hood-like optical lens 1. The reference lug 125 has a different shape from the projections 123 and can therefore serve for setting the angular position of a reflector of a lighting unit. These projections 123 form stop surfaces for the reflector of the lighting unit and together with the mating surface 117 and the reference lug 125 serve to ensure the correctly positioned installation, alignment and arrangement of the reflector in relation to the optical lens 1.

At its end disposed opposite the front face 11, the hood-like optical lens 1 or its sidewall 12 has a circular-ring-shaped, stepped edge 130. The inner diameter of the sidewall 12 is increased in a step-like manner in the region of the stepped edge 130. The edge 130 therefore forms a circularly cylindrical lateral surface 132 on the inside of the sidewall 12 and a ring-shaped mating surface 133 arranged parallel to the front face 11. The lateral surface 132 can therefore define a reference diameter for the spatial orientation and alignment of a light-emitting diode arrangement 3 of a lighting unit in relation to the hood-like optical lens 1. The mating surface 132 adjoins the light-emitting diode arrangement and defines a reference plane for the relative positioning of the optical lens 1 and the light-emitting diode arrangement. In addition, there is a further reference lug 112, formed on the edge 130, which can be used for establishing the relative angular position between the optical lens 1 and a light-emitting diode arrangement.

For reasons of manufacturing technology, the optical lens 1 has on its sidewall 12 two ridges 116 which are located opposite each other and in each case extend from the edge 130 up to the front face 11. The sidewall 12 has an increased wall thickness in the region of the ridges 116.

FIG. 3 shows a schematic cross-section through the optical lens 1 shown in FIGS. 1 and 2. The front face 11 has a ring-shaped flange 140, which is fixed in a ring-shaped groove in the sidewall 12 using an injection molding technique. The sidewall 12 is an injection molded part. In the manufacture of the sidewall 12 the premanufactured front wall 11 is, for example, laid into the mold for the sidewall 12, so that the plastic material for the sidewall 12 is injected around the ring-shaped flange 140. This means that the sidewall 11 can, for example, be made of glass. Alternatively, the front face 11 can also be embodied as an injection molding.

1. An optical lens, shaped like a hood and comprising a light transmissive front face and an adjacent sidewall, wherein the sidewall and the front face form, different components of the optical lens, which are joined to one another by injection molding.

2. The optical lens as claimed in claim 1, wherein the sidewall is embodied as non light-transmissive.

3. The optical lens as claimed in claim 1, wherein the front face and the sidewall are made of different materials.

4. The optical lens as claimed in claim 1, wherein the sidewall is made from a material from the group of polycarbonate, polyamide and polybutylenterephthalate.

5. The optical lens as claimed in claim 1, wherein the sidewall is embodied as an injection molding.

6. The optical lens as claimed in claim 1, wherein the front face is made from a material from the group of polycarbonate, polymethylmethacrylate and glass.
